(19) United States
(12) Patent Application Publication
(10) Pub. No.: US 2015/0235313 A1
(43) Pub. Date: Aug. 20, 2015

(54) METHOD, PROCESS AND SYSTEM FOR TRADING PROFESSIONAL SERVICES

(71) Applicant: SKILLSAPIEN PTY LTD, New South Wales (AU)

(72) Inventor: Victor Jiang, Maroubra (AU)

(21) Appl. No.: 14/429,240

(22) PCT Filed: Sep. 20, 2013
(86) PCT No.: PCT/IB2013/058679

§ 371 Date: Mar. 18, 2015

Related U.S. Application Data
(60) Provisional application No. 61/703,370, filed on Sep. 20, 2012.

(51) Int. Cl. G06Q 40/04

(52) U.S. Cl. CPC G06Q 40/04

(57) ABSTRACT

A method for facilitating a futures contract for professional services between a buyer in a group of buyers and a seller in a group of sellers, wherein seller is a provider of professional services, comprising: buyer notifies an intermediary of a first set desired characteristics; seller notifies the intermediary of second set desired characteristics; intermediately compares first and second set of desired characteristics of all relevant sellers in the group of sellers with all relevant buyers in the group of buyers to find the matches based on relevance and notifies buyer; buyer chooses a preferred seller; buyer and seller agree on terms of the futures contract including: a start and fin date for delivery of the professional services, cancellation fee for buyer and seller, time availability of the seller and fee rates of the seller; and intermediary effects the futures contract between the buyer and seller.

### TECHNICAL FIELD

The present invention relates to a method and/or system for connecting clients to professional service providers in business to business context, which would allow clients to retain professional service providers at a future time for a predetermined period of time or for a predetermined fee by using a futures contract for professional services. The method and system may also include matching services, e-tendering services and other ancillary services.

### BACKGROUND

There has been a long felt need for a system that allows clients to pre-book professional services through the use of futures contracts. This system of pre-booking for professional services may allow clients to book future professional services at a discounted rate for a predetermined period of time. Thereby, locking the current discounted fee rates for the client to use at a future predetermined date. This pre-booking system gives the client a transferable or sellable right for future retained professional services. The client may also treat the futures contract as an asset with a marketable or saleable value.

Previously, other systems of professional service trading have existed to match clients with potential service providers. Systems such as eLance.com, Freelancer.com, Odesk.com all provide web enabled computerized systems for tendering by service providers subject to work requirements issued by potential clients, however these systems may differ from the above-mentioned system in a number of ways:
they generally focus on the service provider bidding for work;
there are no capacities for future booking facilities against service providers;
they do not generally allow clients to lock-in future fee rates of the service provider; and
they do not provide clients with a tradable right on the service contract
Additionally, they lack the ability to adequately match high-end professional service providers with service buyers through multiple dimensions of desired characteristics or attributes. Web based systems such as eLance.com generally perform matches based on keywords search and fails to verify other background factors about service providers. Descriptions of the eLance.com system are available from their website at http://www.elance.com. Descriptions of the freelancer.com system are available from their website at http://www.freelancer.com. Descriptions of the odesk.com system are available from their website at http://www.odesk.com.

U.S. Pat. No. 7,464,051—Heggem describes an online trading system for connecting buyers and sellers. However this system is not applied to professional services or trading of future rights such as futures contracts. The disclosure also doesn't disclose any feature relating to the matching of multiple desired characteristics which may be desirable to match high end professional service providers with suitable service buyers.

It may also be important to note that professional service providers (PSP) often experience a down turn in business and revenue through cyclical economic activity or market downtowns. When this occurs the PSP firm may often suffers underutilization or “bench-time”, wherein the PSP firm's fee-earning staff may be waiting for work and are therefore generally unproductive. The PSP may incur huge losses as a result and may be forced to retrench parts of its workforce to stay solvent. Enabling pre-booking of future professional work by clients could allow the PSP to avoid or limit the effects of sales downturn during tough market conditions, as their time is pre-booked, prepaid and therefore secured. This helps to protect both the PSP's margin and workforce, possibly even during an economic downturn or slump. Meanwhile the client benefits from having the certainty of provision of service and a fixed contractual rate at the pre-determined future date, thereby protecting itself both from potential skill shortages and any universal fee raises by the PSP.

If the client's requirements change or if market conditions are such that selling off the future utilization contract becomes more desirable, the client has the option to sell this futures contract to a third party ahead of the contract start-date, thereby eliminating the commitment and potentially profiting from the sale.

Any discussion of the prior art throughout the specification should in no way be considered as an admission that such prior art is widely known or forms part of common general knowledge in the field.

### SUMMARY

### Problems to be Solved

The present invention aims to address at least some of the problems with the prior art in this field. More specifically, the present invention may aim to reduce or limit “bench time” of internal staff and contractors and maximise staff utilisation levels.

It is an object of the present invention to overcome or ameliorate at least one of the disadvantages of the prior art, or to provide a useful alternative.

### Means for Solving the Problem

One aspect of the present invention is to provide a system for facilitating a futures contract for professional services between a buyer and a seller, comprising: a computer program being run on one or more computer processors and accessing one or more databases within an informational storage component; wherein the informational storage component provides for storing a plurality of buyer groups, a plurality of buyer profiles associated with buyer groups, a plurality of seller groups, a plurality of seller profiles associated with seller groups associated with seller profiles; wherein the buyer profiles and the seller profiles respectively include at least one set of desired attributes; wherein the computer program provides for a seller interface adapted to receive information relating to a seller profile and a buyer interface adapted to receive information relating to a buyer profile; wherein the computer program matches the desired attributes between one buyer profile and at least one seller profile selected from the seller groups to identify a preferred seller and the computer program is adapted to allow the buyer to make an offer for the futures contract to the preferred seller; and further wherein the preferred seller accepts the offer and the computer program effects the futures contract between the buyer and the preferred seller.

Preferably, the desired attributes may include: a depth of skill attribute, a relevance of domain knowledge attribute, an industry and market experience attribute, and/or a psychometric profile attribute.

Preferably, the provisions of the futures contract include: a predetermined fee rate of the seller; a predetermined amount of time the seller is to provide professional services, the nature of services to be performed; and a start and finish date for delivery of the professional services. The system may also display on the buyer or seller interface information relating to an electronic calendar including information relating to the future availability of the seller. Preferably, in such a way that the demand and supply information may be visualized instantly on the aforementioned interface or interfaces.

The future availability of the seller may be agreed upon by both seller and buyer, and forms part of the futures contract.

Preferably, the psychometric profile attribute may identify the seller as from having of the following selected characteristics or attributes: team player, leader, self-starter, follower, introvert, extrovert, etc. This attribute may be compared to desired characteristics or attributes of which the client is seeking as well as team composition dynamics, in order to reach a match that best corresponds to the needs of the client.

The industry and market experience attribute may include data specifying the location or market where the experience was gained. As the preferred system is provided by an online portal adapted to function across the internet, such information may become relevant in certain situations.

Preferably, the discipline of the professional services being considered may be one of, but not exclusively bound by, the following categories: information technology services, engineering services, financial services, legal services, accounting services, research and scientific services, graphic design services, photography services, writing services, translation services, sales and marketing services, business advisory services, creative and artistic (including musical) services, training and educational services, sports and coaching services, medical or health services, culinary and chef services, fashion design and tailoring services, and other services that may be generally considered as professional in nature.

The system may include an electronic tendering system, whereby the buyer posts a service proposal and multiple sellers are invited to make counter proposals and then after a predetermined time period, the buyer selects a preferred seller through buyer interface.

Preferably, the futures contract may be tradeable or transferable at the discretion of the buyer. The futures contract may also include a cancellation fee and wherein said cancellation fee may be between 1 and 150% of the total monetary value of the futures contract. The cancellation fee may be payable by either buyer or seller who defaults or otherwise breaches the futures contract. It may be preferable, to charge cancellation fees in excess of the contract, wherein a punitive measure is required to prevent abuse of the embodiment or system. These punitive cancellation fees may be charged wherein the system has been the subject of abusive gamification by either sellers or buyers.

Preferably, the futures contract may be conditional, whereupon either the seller or buyer may impose certain conditions for fulfilment (for example non-transference of contract), upon which non-satisfaction of the condition may render the futures contract null and void, or rendered with further penalties for the non-complying party.

Another aspect of the present invention is to provide a method for facilitating a futures contract for professional services between a buyer in a group of buyers and a seller in a group of sellers, wherein seller is a provider of professional services, comprising: the buyer notifies an intermediary of a first set desired attributes; the seller notifies the intermediary of second set desired attributes; the intermediary compares first and second set of desired characteristics of all relevant sellers in the group of sellers with all relevant buyers in the group of buyers to find the matches based on relevance and notifies buyer; buyer chooses a preferred seller; the buyer and seller agree on terms of the futures contract including: start and finish dates of the futures contract, cancellation fee for buyer and seller, time availability of the seller and fee rates of the seller; and the intermediary effects the futures contract between the buyer and the seller.

Preferably, the first and second sets of desired attributes may include: a depth of skill attribute, a relevance of domain knowledge attribute, an industry and market experience attribute, and a psychometric profile attribute.

The method may be adapted to be resolved electronically using separate interfaces for the buyer and seller. Preferably, the intermediary is an automated computer program adapted to interact with buyer and seller and wherein the interfaces are web-enabled portals. The intermediary may also comprise of manual process, or manual processes inter-mixed with automated computerized processes

The preferred futures contract may be tradable or transferable at the discretion either buyer or seller. Preferably, the cancellation fee is between 1 and 150% of the total monetary value of the futures contract. Also, the preferred cancellation fee may be payable by either buyer or seller who defaults and/or otherwise breaches the futures contract.

Preferably, the psychometric profile attribute identifies the seller from one of the following selected group: team player, leader, self-starter or follower. The industry and market experience attribute may include data specifying the location of the experience.

Another aspect of the present invention is to provide an electronic interface system for facilitating a futures contract for professional services between a buyer and a seller, including: a buyer interface for use by the buyer, wherein the buyer enters data into buyer interface relating to the preferred time availability to be provided pursuant to the futures contract; a seller interface for use by the seller, wherein the seller enters data into seller interface relating to time availability into seller interface; a computer program, which connects the buyer and seller interface and matches time availability, fee rates and service fit for the booking of a futures contract, wherein the buyer interface and the seller interface are adapted to operate through the internet.

Preferably, the computer program displays time availability in a series of color coded boxes to denote quantity or quality of supply, on either of the buyer interface or seller interface.

In the context of the present invention, the words “comprise”, “comprising” and the like are to be construed in their inclusive, as opposed to their exclusive, sense, that is in the sense of “including, but not limited to”.

The invention is to be interpreted with reference to the at least one of the technical problems described or affiliated with the background art. The present aims to solve or ameliorate at least one of the technical problems and this may result in one or more advantageous effects as defined by this specification and described in detail with reference to the preferred embodiments of the present invention.

### BRIEF DESCRIPTION OF THE FIGURES

Embodiments of the present invention will now be described with reference to the drawings in which:

FIG. 1 is a graph depicting the outcomes for professional services providers using the first preferred embodiment of the present invention;

FIG. 2 is a chart showing at least some of the desired attributes used in the matching process in relation to the first preferred embodiment of the invention;

FIG. 3 depicts an example screen capture of an online portal or interface using the system and/or method described of the first preferred embodiment;

FIG. 4 depicts a flowchart view of a payment process to be used with or within the first preferred embodiment of the present invention;

FIG. 5 depicts a schematic layout of the system included within the first preferred embodiment;

FIG. 6 depicts an example screen capture of an interface matching date and time information on a daily basis;

FIG. 7 depicts an example screen capture of an interface matching date and time information on an hourly basis; and

FIG. 8 depicts an example screen capture of at least some of the buyer or seller profile information as shown in the interface.

### DESCRIPTION OF THE INVENTION

Preferred embodiments of the invention will now be described with reference to the accompanying drawings and non-limiting examples.

In this specification, a futures contract is a standardized contract between two parties to buy or sell a specified asset of standardized quantity and quality for a price agreed today (the futures price or strike price) with delivery and payment occurring at a specified future date, the delivery date. In this specification, the futures contracts are negotiated preferably through an intermediary acting between the buyer and seller. Preferably, this intermediary is a computer program as described within the first preferred embodiment of the present invention. The party agreeing to buy the underlying asset in the future, the “buyer” of the contract, is said to be “long”, and the party agreeing to sell the asset in the future, the “seller” of the contract, is said to be “short”. The terminology reflects the expectations of the parties—the buyer hopes or expects that the asset price is going to increase, while the seller hopes or expects that it will decrease in near future. Generally in this specification, the buyer may include a professional services client; and the seller may include PSP or high end PSP. The preferred seller is a high end PSP.

While the futures contract specifies a trade taking place in the future, the purpose of the intermediary may be to minimize the risk of default by either party. Thus the intermediary may require one or both parties to put up an initial amount of cash, the margin. Additionally, since the futures price may generally change regularly, the difference in the prior agreed-upon price and the daily futures price may also be settled at regular intervals (variation margin). The intervals may be daily but the length of time may depend on the predetermined circumstances of the transaction. The exchange will draw money out of one party's margin account and put it into the other's so that each party has the interim loss or profit. If the margin account goes below a certain value, then a margin call is made and the account owner must replenish the margin account. Thus on the delivery date, the amount exchanged may not be the specified price on the contract but the spot value (since any gain or loss has already been previously settled by marking to market).

Unlike an option, both parties of a futures contract must fulfil the contract on the delivery date. The seller delivers the underlying asset to the buyer, or, if it is a cash-settled futures contract, then cash is transferred from the futures trader who sustained a loss to the one who made a profit. To exit the commitment prior to the settlement date, the holder of a futures position can close out its contract obligations by taking the opposite position on another futures contract on the same asset and settlement date. The difference in futures prices may be then a profit or loss.

To minimize counterparty risk to traders, trades executed on regulated futures exchanges are guaranteed by a clearing house. The clearing house becomes the buyer to each seller, and the seller to each Buyer, so that in the event of a counterparty default the clearer assumes the risk of loss. This enables traders to transact without performing due diligence on their counterparty.

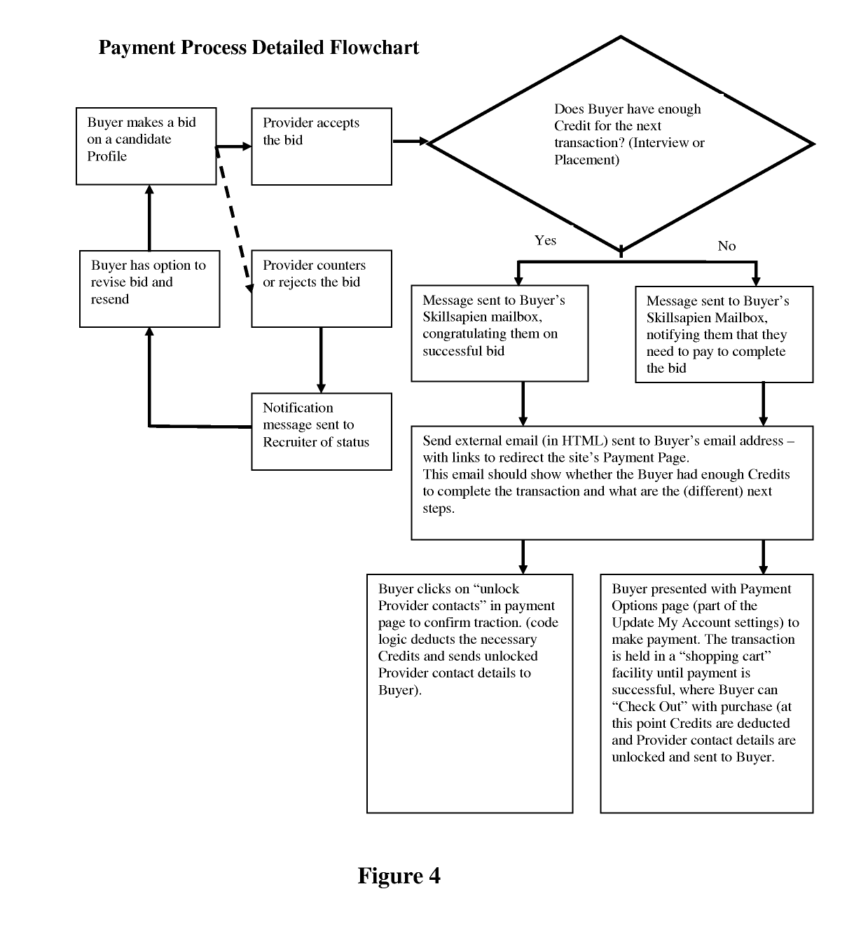

Settlement is the act of consummating the contract, and can be done in one of two ways, as specified per type of futures contract:
Physical delivery—the amount specified of the underlying asset of the contract is delivered by the seller of the contract to the exchange, and by the exchange to the buyers of the contract. In practice, it occurs only on a minority of contracts. Most are cancelled out by purchasing a covering position—that is, buying a contract to cancel out an earlier sale (covering a short), or selling a contract to liquidate an earlier purchase (covering a long);
Cash settlement—a cash payment is made based on the underlying reference rate, or the closing value of a stock market index. The parties settle by paying/receiving the loss/gain related to the contract in cash when the contract expires. Cash settled futures are those that, as a practical matter, could not be settled by delivery of the referenced item—i.e. how would one deliver an index? A futures contract might also opt to settle against an index based on trade in a related spot market; and
Electronic Delivery—by the method or process depicted in FIG. 4 and further described in this specification.

Expiry (or Expiration) is the time and the day that a particular delivery month of a futures contract stops trading, as well as the final settlement price for that contract. The Expiry date may also be referred to as the finish date of the professional services. Preferably, the start date described in this specification refers to the predetermined and agreed start time of the professional services, which may be different or same as the commencement date of the futures contract.

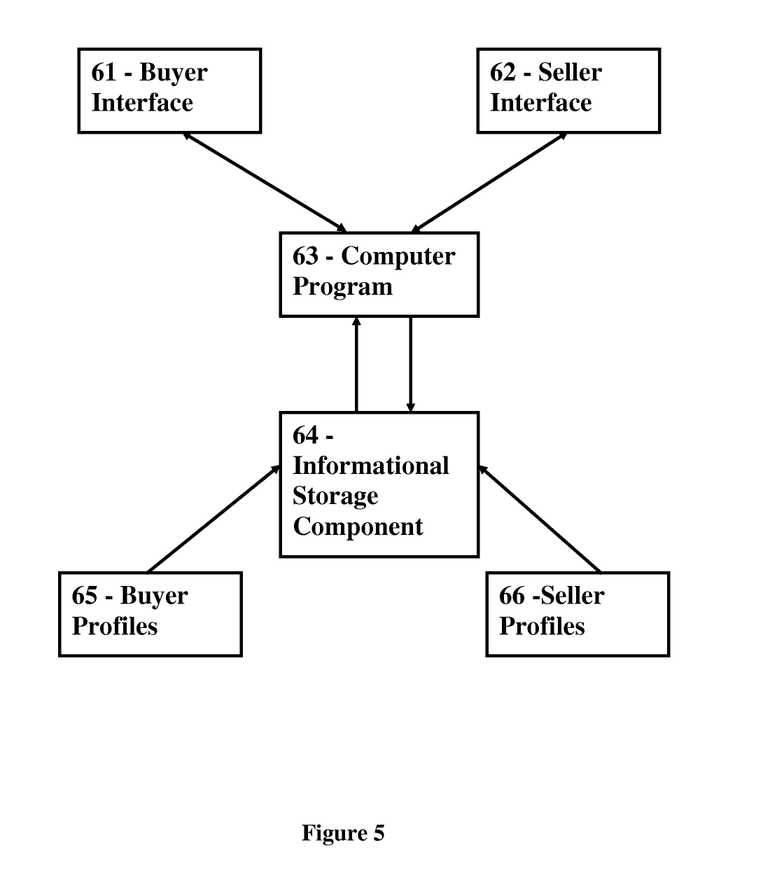

In a first preferred embodiment of the present invention, a system comprising the preferred components depicted in FIG. 5. This preferred system, method or process includes: a computer program 63 connected to: buyer interface 61, seller interface 62, and informational storage component 64; buyer profiles 65 and seller profiles 66 connected and integrated into the informational storage component 64. The computer program 63 is adapted to run and manage the system, method or process.

Preferably, the computer program 63 is adapted to be run on a computer processor and accessing a database within the informational storage component 64.

In this embodiment, the computer program 63 is adapted to run across a web enabled environment wherein the buyer and seller interfaces 61 & 62 are specialized web portals to enabled buyers and sellers to input and receive information. The computer program 63 using the system may match the buyers with the sellers using predetermined desired attributes.

The computer program 63 may suggest or recommend sellers to a buyer based desired attributes inputted by the buyer. The buyer selects a preferred seller and then the computer program sends a notification to the selected seller. Then the seller and buyer agreed by use of the computer program and the respective interfaces to an electronic futures contract.

Preferably, the buyer may input into the buyer interface 61 a first set of desired attributes. These desired attributes are attributes that the buyer wishes to secure by way of this system. This first set of desired attributes may be stored in the buyer profile 65 for retrieval and matching purposes of the computer program 63.

Additionally, the seller may also input a second set of desired attributes into the seller interface 62 and this second set of desired attributes are stored in seller profiles 66.

Preferably, the computer program 63 matches and/or identifies buyers and sellers in terms of relevancy of their matches of the first and second sets of desired attributes. The computer program 63 may then identify multiple sellers from the respective seller profile to match a single buyer profile and these may be displayed on the buyer interface in order of relevancy or proximity of matches to the first set of desired attributes.

The electronic futures contract of the first preferred embodiment is an agreement between the buyer and seller that the buyer has purchased a desired amount of time at a predetermined fee rate to be used before the finish or expiry date of the professional service. It is noted that the computer program 63 may also function as a type of electronic clearing house to facilitate the transactions.

Preferably, the futures contract includes provisions whereby the seller agrees to allocate a given professional's time for a predetermined time period to buyer. If the seller defaults on the futures contract, by chose or by being unable to provide said service, the seller must pay a cancellation fee. Generally, the cancellation fee(s) are relatively sizeable when compared to the overall value of the futures contract and this is aimed to discourage sellers from defaulting on said futures contract.

The buyer may agree to the pay for the entire cost of the futures contract at the time the contract is agreed or agrees to pay a processing fee at the time of execution of the futures contract and the remainder of the fees on completion of the professional services. If the buyer defaults depending on the contract there may be a relatively sizeable cancellation fee or alternatively the buyer may forego the entire cost of the contract. The outcome depends on the provisions of futures contract as agreed by the parties.

It is envisaged that the professional services provided for under the futures contract will be at a discounted rate which is agreed between the buyer and seller at the time of time of settlement of the futures contract.

Preferably, the futures contract, brought into effect by this system and method, would be tradable and transferable to third party buyers. However, it is envisaged that the seller would not be able to transfer or cancel the futures contract except for: default; or wherein the cancellation is due to professional conflict of interest with the new buyer.

Preferably, the cancellation fee payable on a defaulted futures contract would be a relatively high percentage of the total overall value of the contract to discourage contract breaches. Preferably, the cancellation fee may be in a range between 1 to 150% of the total overall contract value.

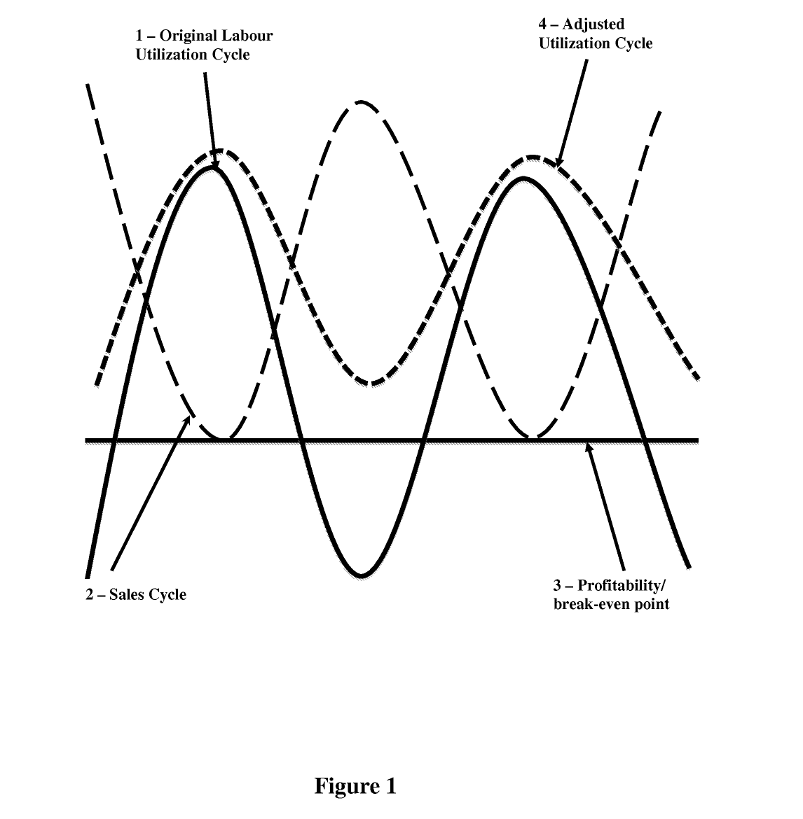

The preferred benefits and uses of the system, process or method according to the first preferred embodiment are depicted in FIG. 1 of the accompanying drawings. FIG. 1 depicts a graph with a break-even point 3 or a profitability line plotted along the x axis. The break-even point or profitability line depicts the region on the graph under which utilization of resources is non-profitable.

Plotted against the profitability line 3 is the billable utilization cycle line 1. In this example, the billable utilization cycle line 1 represents the generic billable utilization of professional services by a hypothetical company under normal circumstances without use of professional service futures contracting. The utilization cycle, in this embodiment, fluctuates in a hypothetical sinusoidal pattern typically of boom and bust economic modelling.

Also plotted on the graph shown in FIG. 1 is a pre-sales cycle line2. This pre-sales cycle line 2 is typically representative of the pro bono sales activity required to generate billable work, and is typically the inverse of billable utilization rates within a company. In this example, pre-sales fall when billable utilization is high, pre-sales increase when billable utilization is low. This means that when utilization cycle line 1 is at the top of the peak, all or most professional services providers are fully or close to being fully booked and available resources are low. Whilst when utilization cycle line 1 is at the bottom of the trough, unused labour rate is at its highest.

When staff or employees of an organization are employed by a professional services business or company but not actively engaged in pre-sales or billable work, this is sometimes referred to as “bench time”. One of the aims of the present embodiment is to minimise “bench time” and to ensure that billable utilisation rates are maximised.

This first preferred embodiment of the present invention may aim to de-risk the sales cycle for seller or professional service provider by preselling professional services to clients or buyers through futures contract. This may allow the seller to make increases in staff utilization rates even in times of an economic downturn. The effect is that the minimum of the utilization cycle is raised and this adjustment to the utilization cycle is shown in the graph at adjusted utilization cycle 4. The maximum of the adjusted utilization cycle 4 has remained unchanged as it is assumed for this example that in a booming economy the hypothetical company has reached a finite maximum of sales as all staff are fully utilized and the company or organization would need to employ more people to generate increased revenues. In times of an economic downturn or a trough, the seller has already pre-sold professional services and thus lifts the minima of the utilization rate. This may mean that the company is delivering on earlier sales and generating revenue, even though buyers may not otherwise require the services at that time. The futures contracts have the overall general effect of stabilizing the billable utilization rates for seller and may effectively transfer the price fluctuation risk to the buyer. It may also return the company or business to a profitable status (i.e. above the break-even point 3) even in time of economic downturn.

It is noted that many organizations that provide high end professional services do experience “utilization lag” which also means that the staffing numbers are out of sync with the sales. This also may mean that the sales numbers are not being maximized as some companies retrench staff in busting economies and rehire staff in booming economies causing a lag between current net resources and current net resources required. The first preferred embodiment avoids and mitigates utilization lag.

For the buyer, the main advantage may be that they are able to secure a significant discount on future professional services which will be needed by them. A buyer may be aware that they will need professional services in the future to complete a project and may be speculate on the price of such professional services in the event of discount.

Also, the buyer obtains an asset from the formation of the futures contract. If the buyer locks in a futures contract for professional services at a time of economic weakness, when the economy moves to boom phase, the buyer can sell the futures contract to a third party and make a profit even if the professional services were never needed by them.

The first preferred embodiment may aim to match supply with demand through futures contracts and allow buyers to acquire best value skills, whilst minimizing bench time and maximizing profitability for the seller.

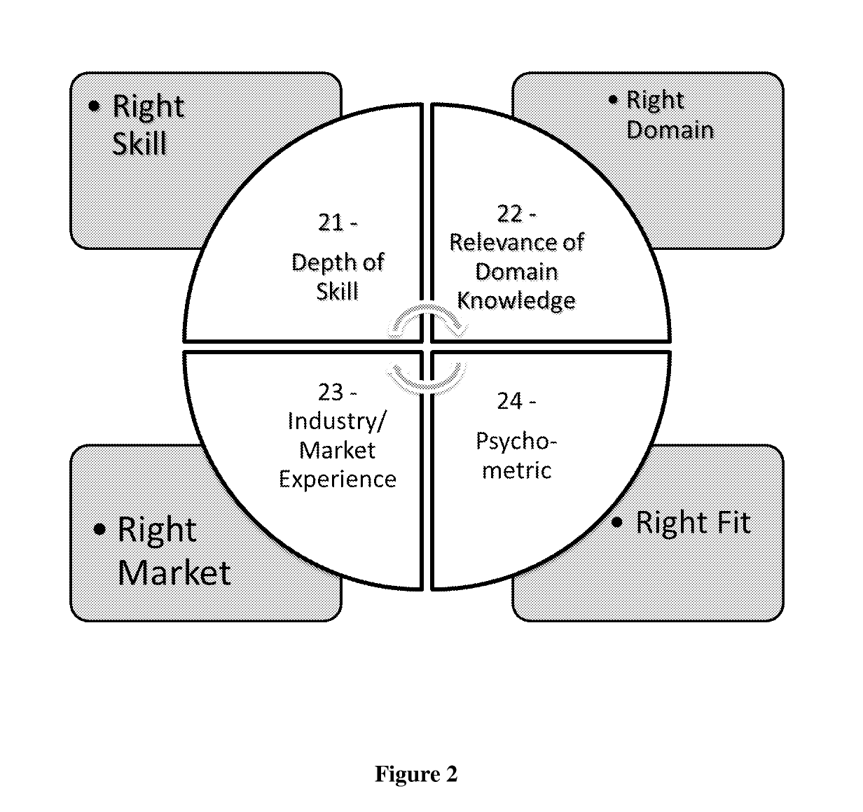

FIG. 2 depicts a preferred four dimensional matching system to be used with or incorporated into the first preferred embodiment. The four dimension matching system or 4d matching shown in FIG. 2 depicts four main characteristics or attributes that may be used as desirable attributes or characteristics for matching buyers and sellers.

The preferred four desired attributes are: depth of skill 21, relevance of domain knowledge 22, industry/market experience 23, and psychometric elements and/or data.

The depth of skill 21 attribute may measure whether the professional services provided by the seller are the right skill for the buyer. More specifically, depth of skill determines whether the PSP has the right skills and/or qualifications to complete the project for the buyer. For example, the seller has Java™ programming skills; Oracle™ programming skills; or is a qualified accountant or lawyer.

The industry/market experience 23 attribute refers to the skills of seller being based in the right industry for buyer. Importantly, the definition of this characteristic may be region focused and this may mean that seller would need to be in the right industry at the right place. For example, the seller may have industry/market experience in relation to “investment banking in London, UK”.

The relevance of domain knowledge 22 characteristic refers to the seller having the knowledge in the right domain. The right domain is narrower than industry/market experience and is a subset thereof. For example, the right domain for a seller may be “credit derivatives” which is a subset of “investment banking in London”.

The psychometric 24 characteristic relates to psychometric profile obtained from the seller. This allows the buyer to evaluate what role the professional services provider will play in the project for which for the futures contract is needed. The psychometric profile or data used for this characteristic may be recorded or acquired from standard psychometric testing procedures, such as the Canadian Medical Examination Profiling System or Myers Brigg Tests. Preferably the outcomes of the psychometric testing should give rise to characteristic identification of the seller that includes whether they possess: team player characteristics, leader characteristics, follower characteristics, and/or self-starter characteristics. Preferably, the seller may volunteer this information at the time of creating their profile. The Myers Brigg Test may also give rise to additional profiling information including whether the party subject of the test falls within established criteria including but not limited to extraversion or introversion.

Preferably, the matching of buyer and seller may be completed electronically by a computer program operating through web enabled portals. Preferably, the computer program may compare all four of the preferred desired characteristics of the seller profile and compare that to the chosen characteristics of buyer as stored in their respective buyer profile. The matches may be displayed on buyer or seller interfaces in terms of relevancy or a percentage calculated from the proximity of match between the respective profiles.

Preferably, the matching of time availability data of the buyer and seller may be displayed on buyer interface and/or seller interface. The display of this information may be achieved by colour coding time slots with coloured boxes on a screen depicting a visual calendar (such as the calendar used in Outlook™ or Apple iCal™) Time slots may be any chosen or preferred time grouping (chosen by the seller). Time slots may be hourly, daily, half daily, weekly, monthly, annually or even six minute time intervals. Green coloured boxes may mean the particular time slot is available for booking. Red coloured boxes may mean the particular time slot is unavailable for booking. Amber or yellow coloured boxes may mean the particular time slot is available for booking by separate negotiation with the Seller.

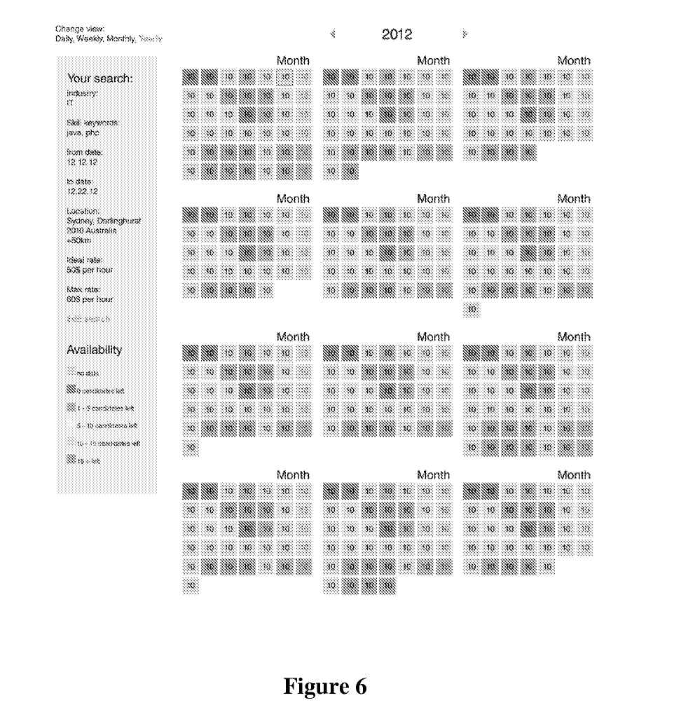

An example of the time availability screens are depicted in FIGS. 6 & 7. In these figures, the seller or the candidate may individually upload time availability data to the computer system. In FIG. 6, the time availability is shown on a daily basis to assist the buyer in making decisions as to whether to proceed with a seller. FIG. 6 shows aggregated data of time availability of all suppliers meeting or matching the desired attributes of the buyer. In this example, the number of sellers that are available is colour coded into groups of the availability slot. The slots are coloured according to the amount of sellers available at a predetermined time interval. The following groupings are shown in order of the most sellers available to the least amount of sellers available:

a) Blue

b) Green

c) Yellow

d) Orange

e) Red

The colour grey is used to denote that no suppliers are available for the criteria searched. Additionally, the preferred computer program will adjust the number of sellers in each colour group based on the total number of sellers available to meet the desired attributes of the buyer.

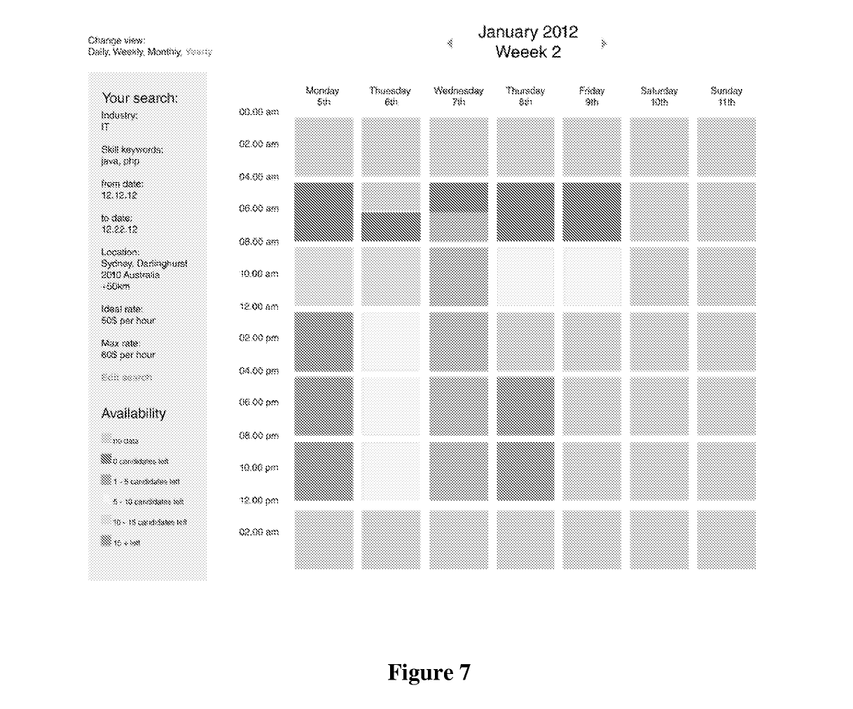

FIG. 7 depicts a detailed version of the time availability data. In this example, the time availability data is displayed for a single hypothetical candidate, wherein the candidate's time is colour coded for instantaneous visual comparison and reference. In this example, the displayed data may be colour coded into the following categories: red meaning the candidate is not available for the time period; amber meaning partial availability or availability that needs to be discussed and resolved with the candidate; or green meaning that the candidate is available for booking for the desire time period.

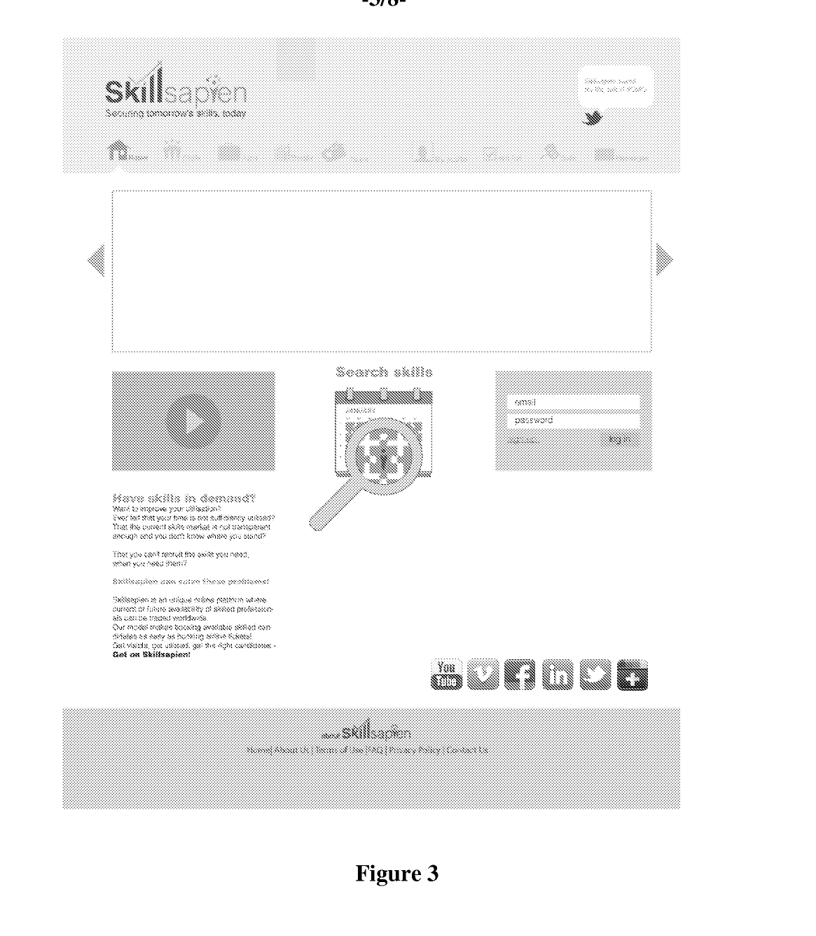

FIG. 3 depicts a visual representation of an example portal interface to be used with or integrated within the first preferred embodiment of the present invention. Preferably, the interface screen includes a login area or region for users to login and identify themselves to the system. The logged users will be identified as either buyers or sellers of professional services. The interface will be modified to display information relevant to the user.

Further the buyers will be able to enter into the system a profile of the desired characteristics that they are looking. These desired characteristics are chosen from the 4d matching characteristics above described. Additionally, they will be required to enter further data including: amount time to be allocated for their project, rate ranges, start and finish dates and other relevant information.

The seller will be required to enter a seller profile into the interface. The seller profile will have similar information to the buyers profile but it may also include a system for entry of time availability. This will allow for time of professional service provider to be booked without otherwise double booking their services.

Preferably, the interface is adapted to interact with users being buyers or sellers over the internet. Further, the system may include Facebook™ integration, Linkedln™ integration or other social media integration. Recommendation systems of LinkedIn and Facebook may be integrated and displayed as part of the seller or buyer profile to aid people looking to enter these types of futures contracts.

Preferably, the interfaces would also include the capacity for the buyer to book time directly onto the seller electronic calendars. To accomplish this, the seller interface includes an electronic calendar wherein the time slots of predetermined time increments are shown (e.g. 1 hour blocks). Each block, the seller may have designated their availability to be booked through the futures contract system herein described. On the buyer interface, the buyer will see visually the available time slots or blocks of the seller and can pre-book the seller through the futures contract mechanism or system.

Alternately, the preferred system may integrate with electronic calendars systems provided on Google™, Microsoft Outlook™, or Apple iOS™. The integration may be achieved by predetermined time intervals synchronization of data between the various technology platforms. These synchronizing systems are well known in the field of IT and web functionality platforms.

FIG. 4 of the accompanying drawings depicts a schematic view of a possible payment structure, process and method that may be implemented along with or as part of the first preferred embodiment of the present invention.

In this figure, the process begins with the buyer (which is also referred to in this specification as the buyer profile) making a bid on the seller's profile. The seller accepts or rejects the bid. If the bid is rejected, the process or system then may request for a counter offer or counter bid from the buyer.

If the bid is accepted by the seller, the process or system then may assess whether the buyer has funds available for the transaction or enough credit for the futures contract. The futures contract in this figure is labelled placement.

If the buyer has the appropriate funds available, a confirmation email is sent to the buyer's email address which is stored in the buyer profile. The email includes a link to redirect the user to a preferred payment options website (for example PayPal™) and the recruiter completes the contract with an electronic confirmation on the website. The payment options site may preferably be set out as an online shopping cart which is commonly known and well described on the internet. The contact details of seller or candidate are then fully unlocked to the buyer, once payment has been confirmed and receipts have been automatically sent to relevant parties.

Various high end professional skills that may be the subject of futures contracts under the described system or method of the first preferred embodiment, may generally include the following general types: informational technology services, engineering services, financial services, legal services, accounting services, research and scientific services, graphic design services, photography services, writing services, translational services, sales and marketing services, business advisory services, creative and artistic (including musical) services, training and educational services, sports and coaching services, medical and health services, culinary services and chef services, fashion design and tailoring services.

Generally, high end professional services differ from regular professional services in that the high end professional services require: a greater level of skills and training; and generally more client/buyer interaction.

For example, legal services may be supplied by a specific legal advisor working within a law firm with a high level skills, expertise, experience, and may be also skilled at working with difficult or complex situations which surpass regular provision of legal services.

Preferably, the system may also include an automatic verification system wherein qualifications and education of professional service providers or sellers is verified. Also the system may include an additional system for verifying that the buyer can pay for the futures contract by way of a verified: bank account, credit card, Skrill™ or PayPal™ account.

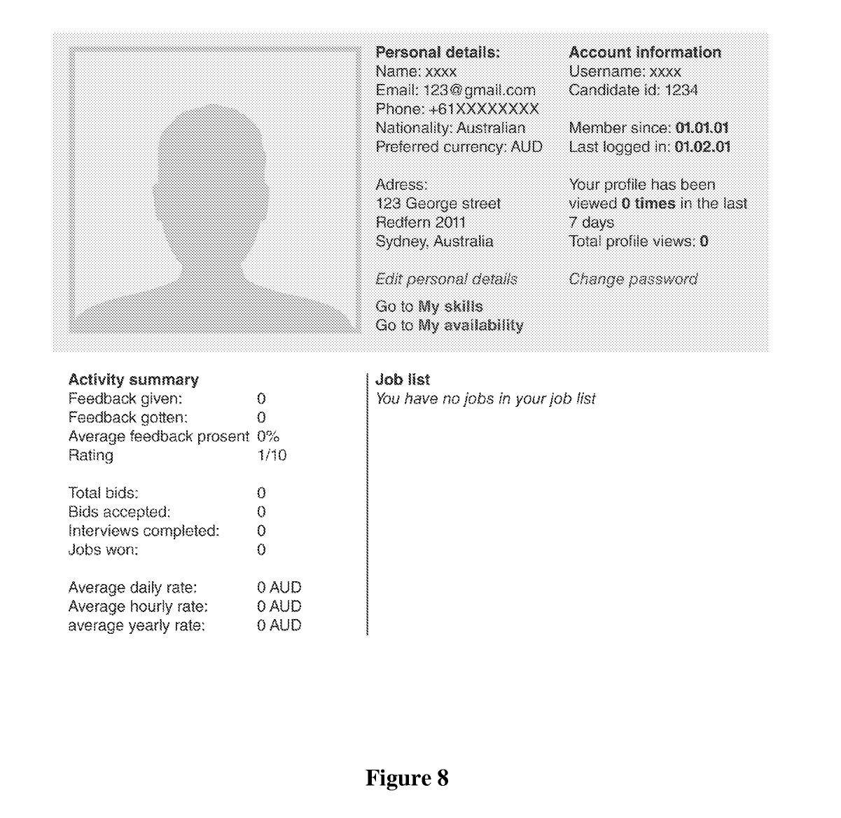

An example of a profile depicted in a respective interface is shown in FIG. 8. In this example, a fictional candidate's information is shown. The interface displays information from the respective profile including: a photo of the candidate, contact details, name, user identification, usage records, availability data and feedback rating scores. The feedback rating scores may be generated by third party reviews and recommendations of the services provided by the candidate. Preferably, they may incorporate a star based rating system in which stars are used to visually show the quality of service of the candidate.

From the profile screen depicted in FIG. 8, the user may be able to access additional records in the computer system including other desired attributes. FIG. 8 shows links to “My Skills” which is a subset display of the data relating the depth of skill attribute 21, and “My Availability” which is a subset of the time availability of the candidate.

Preferably, the system may also be adapted to include an electronic tendering system whereby jobs may be posted by buyers and multiple sellers confidentially propose agreements. The buyer may, after a predetermined time has elapsed, select a professional service provider or seller from the tenders and automatically enact a futures contract based on the conditions proposed and agreed between the buyer and selected seller.

Preferably, all transactions and futures contracts processed by the system or method would include a predetermined agent's fee being paid to the system or method operator. This fee will be determined by the operator prior to enacting the futures contract between the buyer and seller.

In this first preferred embodiment of the present invention, the computer program may function as an intermediary between the buyer and seller. It is noted that other intermediaries may be used instead of the computer program, namely, a person following the same method as the above described computer program could be regarded as an alternative intermediary.

In a further embodiment of the present invention or an improvement to the first embodiment, a method, process or system may be provided wherein it has been designed within the preferred system to enable a single user to “register” multiple Skill Profiles—each representing one facet of that user's experience, knowledge, qualifications and other attributes that may be desirable for a buyer to know.

Each user may have unlimited numbers of Skill Profiles (SP).

Each SP may include the following attributes as a minimum:

Skill Profile Title (1:1)

Skill Profile Summary Description (1:1)

Skill Profile Keywords (1:n)

Relevant Experiences (1:n)

Relevant Qualifications (1:n)

Relevant Languages (1:n)

Client Ratings (1:n)

Availability Calendar (1:1)

Pricing (1:1)

Intellectual Assets (1:n)

As a result, each user may have n^{th} (i.e. unlimited) variations of the above set of attributes to present to a potential buyer, within the one user account. However the aforementioned variations are preferred.

An example of this method, process or system is demonstrated in the following example:
A user has two (2) Skill Profiles defined: SP-A and SP-B (with unrelated skillsets)
He or she may choose to represent SP-A as available between Mondays to Thursdays for 6 hours per day, at an hourly rate of $200
He or she may choose to represent SP-B as available between Wednesdays to Fridays each week for 4 hours per day, at an hourly rate of $350
A buyer thus can see both SP-A and SP-B
The buyer decides to make bookings against SP-A for 24 hours (4 days in this case), and SP-B for 12 hours (3 days)
The same user has thus fully utilised his/her available working hours for the week, with 10 hours on Wed between SP-A and SP-B, 6 hours on Monday-Tuesday; 4 hours on Thursday-Friday, for a total billing of $9000.

This feature may afford the user much greater flexibility to market his/her diverse skillsets while maximising utilisation and profitability. For the buyer, having greater choice and exposure to a more diverse set of Skill Profiles leads to greater efficiency and ultimately value.

Additional Improvement—Team Profiles

Professional services trading system should preferably include an element or feature that allows the interaction of team and it may be important to recognise that sometimes required skillsets are held amongst a collection of individuals. To reflect this situation and enable effective trading within the system, a following improvement was developed to aid in this functionality: Team Profiles.

A Team Profile (TP) may include a collection of individual Skill Profiles, organised in a way that represents greater value for a potential buyer.

It is important at this point to note the relationship between a (provider) user, a SP and a TP:

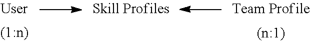

In addition to listing the individual Skill Profiles within a team, each Team Profile typically has the following attributes:
Team Profile Title (1:1)
Team Profile Summary Description (1:1)
Team Profile Keywords (1:n)
Relevant Team Experiences—not to be confused with individual SP experiences (1:n)
Relevant Team Qualifications—not to be confused with individual SP qualifications (1:n)
Team Client Ratings—not to be confused with individual SP client ratings (1:n)
Team Availability Calendar (1:1)
Team Pricing (1:1)
Team Intellectual Assets (1:n)

This feature may enable a team of individual SP to be grouped for more efficient utilisation. For example, a team administrator can combine more some expensive SP with less expensive SP to achieve a “blended rate” that is more profitable than billing out individual SP.

Additional Improvement—Company Profiles

To allow effective administration and tracking of Skill Profiles and Team Profiles, it may be useful to associate them to a working organisation. This is the concept and method behind Company Profiles.

A Company Profile may be described as a profile of a working organisation, typically a legal entity such as a consultancy or a law firm. It can have one or more assigned Company Administrators (super-users).

A Team Profile is typically associated with a Company Profile, while a Skill Profile may not necessarily have to be. A Company Administrator has access to see and modify Skill Profiles or Team Profiles belonging to that Company, including combining Skill Profiles to form teams and assigning separate team administrators to that team.

Buyers can search Skill Profiles or Team Profiles by Company, along with any other qualifying search attributes.

Additional Improvement—Packaged Offerings

Building on the concept of Team Profiles and Company Profiles, a further improved method, process or system may be created for grouping collections of resources across different teams and/or companies, called: Packaged Offerings.

Packaged Offerings may be a package of services from a potentially diverse range of providers, for a fixed fee, for a fixed duration.

Examples of some Packaged Offerings may include the following itemised table. Please note that numbers and figures have been supplied as an example:

| | | Cost/ |
|---|---|---|
| Package | Offerings | Duration |
| #1 | One of: | $500/ |
| | 2 hours from an expert CFO, or | month |
| | 2 hours from an expert CTO/CIO, or | |
| | 2 hours from an expert startup lawyer, or | |
| | 2 hours from an expert sales coach, or | |
| | 2 hours from an expert marketing specialist, or | |
| | 2 hours from a serial entrepreneur/CEO advisor | |
| #2 | One of: | $4000/ |
| | 8 hours from an expert CxO, or | month |
| | 6 hours from an expert corporate lawyer or IP | |
| | attorney | |
| #3 | Either: | $10,000/ |
| | 20 hours from an expert CxO, and | month |
| | 80 hours from experienced mid-level professional | |
| | Or: | |
| | 14 hours from an expert corporate lawyer or IP | |
| | attorney | |
| | 50 hours from an experienced para-legal | |
| | professional | |

These packages may be constructed/contracted between different service providers across different companies, for one simple, fixed cost for the buyer.

All the availability booking and ratings functionalities mentioned previously still apply, providing greater visibility, flexibility, and choice for both buyers and providers.

It has the added benefits for the provider of delivering secured cash-flow and certainty of future utilisation, true to the stated goals of futures contracts for professional services.

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrial applicable.

The claims defining the invention are as follows:

1. A system for facilitating a futures contract for professional services between a buyer and a seller, comprising:
a computer program being run on one or more computer processors and accessing one or more databases within an informational storage component;
wherein the informational storage component provides for storing a plurality of buyer groups, a plurality of buyer profiles associated with buyer groups, a plurality of seller groups, a plurality of seller profiles associated with seller groups associated with seller profiles;
wherein the buyer profiles and the seller profiles respectively include at least one set of desired attributes;
Wherein the computer program provides for a seller interface adapted to receive information relating to a seller profile and a buyer interface adapted to receive information relating to a buyer profile;
Wherein the computer program matches the desired attributes between one buyer profile and at least one seller profile selected from the seller groups to identify a preferred seller and the computer program is adapted to allow the buyer to make an offer for the futures contract to the preferred seller;
And further wherein the preferred seller accepts the offer and the computer program effects the futures contract between the buyer and the preferred seller.

2. The system of claim 1, wherein the desired attributes include: a depth of skill attribute.

3. The system of claim 2, wherein the desired attributes include: a relevance of domain knowledge attribute.

4. The system of claim 3, wherein the desired attributes include: an industry and market experience attribute.

5. The system of claim 4, wherein the desired attributes include: a psychometric profile attribute.

6. The system of claim 5, wherein the provisions of the futures contract include: a predetermined fee rate of the seller; a predetermined amount of time the seller is to provide professional services; a start and finish date for delivery of the professional services.

7. The system of claim 6, wherein the system is adapted to display on buyer interface or seller interface information relating to an electronic calendar including information relating to the future availability of the seller.

8. The system of claim 7, wherein the future availability of the seller is agreed upon by both seller and buyer, and forms part of the futures contract.

9. The system of claim 5, wherein the psychometric profile attribute identifies the seller from one of the following selected group: team player, leader, self-starter or follower.

10. The system of claim 5, wherein the industry and market experience attribute include data specifying the location of the experience.

11. The system of claim 1, wherein the system is provided by an online portal adapted to function across the internet.

12. The system of claim 5, wherein the professional services may be selected from one of the following group: informational technology services, engineering services, financial services, legal services, accounting services, research and scientific services, graphic design services, photography services, writing services, translational services, sales and marketing services, business advisory services, creative and artistic (including musical) services, training and educational services, sports and coaching services, medical and health services, culinary services and chef services, fashion design and tailoring services

13. The system of claim 5, wherein the system includes an electronic tendering system, whereby the buyer posts a job proposal and multiple sellers are invited to make counter proposals and then after a predetermined time period, the buyer selects a preferred seller through buyer interface.

14. The system of claim 1, wherein the futures contract is tradable or transferable at the discretion of the buyer.

15. The system of claim 14, wherein the futures contract includes a cancellation fee and wherein said cancellation fee is between 1 and 150% of the total monetary value of the futures contract.

16. The system of claim 15, wherein the cancellation fee is payable by either buyer or seller who breaches the futures contract.

17. A method for facilitating a futures contract for professional services between a buyer in a group of buyers and a seller in a group of sellers, wherein seller is a provider of professional services, comprising:
a. The buyer notifies an intermediary of a first set desired attributes;
b. The seller notifies the intermediary of second set desired attributes;
c. The intermediary compares first and second set of desired characteristics of all relevant sellers in the group of sellers with the buyer to find the matches based on relevance and notifies buyer;
d. The buyer chooses a preferred seller;
e. The buyer and the preferred seller agree on terms of the futures contract including: a start and finish date for delivery of the professional services, cancellation fee for buyer and seller, time availability of the seller and fee rates of the seller; and
f. The intermediary effects the futures contract between the buyer and seller.

18. The method of claim 17, wherein the first and second sets of desired attributes include: a depth of skill attribute, a relevance of domain knowledge attribute, an industry and market experience attribute, and a psychometric profile attribute.

19. The method of claim 18, wherein the method is adapted to be resolved electronically using separate interfaces for the buyer and seller.

20. The method of claim 19, wherein the intermediary is an automated computer program adapted to interact with buyer and seller and wherein the interfaces are web-enabled portals.

21. The method of claim 20, wherein the futures contract is tradable or transferable at the discretion of the buyer.

22. The method of claim 21, wherein the cancellation fee is between 1 and 150% of the total monetary value of the futures contract.

23. The method of claim 22, wherein the cancellation fee is payable by either buyer or seller who breaches the futures contract.

24. The method of claim 23, wherein the psychometric profile attribute identifies the seller from one of the following selected group: team player, leader, self-starter or follower.

25. The method of claim 24, wherein the industry and market experience attribute include data specifying the location of the experience.

26. An electronic interface system for facilitating a futures contract for professional services between a buyer and a seller, including:
a. A buyer interface for use by the buyer, wherein the buyer enters data into buyer interface relating to the preferred time availability to be provided pursuant to the futures contract;
b. A seller interface for use by the seller, wherein the seller enters data into seller interface relating to time availability into seller interface;
c. A computer program, which connects the buyer and seller interface and matches time availability for the booking of a futures contract, wherein the buyer interface and the seller interface are adapted to operate through the internet.

27. The system of claim 26, wherein the computer program displays time availability in a series of colour coded boxes on either of the buyer interface or seller interface.
